(19) United States
(12) Patent Application Publication
(10) Pub. No.: US 2004/0195952 A1
(43) Pub. Date: Oct. 7, 2004

(54) Shadow mask for color cathode ray tube and color cathode ray tube

(76) Inventor: Mizuki Murata, Tokyo (JP)

Correspondence Address: BIRCH STEWART KOLASCH & BIRCH, PO BOX 747, FALLS CHURCH, VA, 22040-0747, US

(21) Appl. No.: 10/688,877

(22) Filed: Oct. 21, 2003

(30) Foreign Application Priority Data
Apr. 3, 2003 (JP) 2003-100235

(51) Int. Cl. H01J 29/80

(52) U.S. Cl. 313/402

(57) ABSTRACT

In a shadow mask (7) for a color cathode ray tube, there are a region (23) having only dummy bridges (21), and a mixed region (24) having the dummy bridges (21) and real bridges (22). A dummy bridge size in the region (23) having only the dummy bridges (21) is greater than a dummy bridge size in the mixed region (24) having the dummy bridges (21) and the real bridges (22). The vertical size of the region (23) having only the dummy bridges (21) is greater than 50 percent of the vertical size of the shadow mask.

### BACKGROUND OF THE INVENTION

1. Field of the Invention

The present invention relates to a shadow mask for a color cathode ray tube, and a color cathode ray tube.

2. Description of the Background Art

Shadow masks for color cathode ray tubes which have real bridges are known in the art. There is an example of the shadow masks of this type in which the number of real bridges are reduced to suppress the doming effect resulting from heat transfer through the real bridges and dummy bridges are disposed in place of the real bridges to avoid the deterioration of visibility due to the reduced number of real bridges which in turn become more conspicuous (for example, U.S. Pat. No. 4,926,089, col. 13, lines 48-64, and FIG. 12).

Another example of the shadow masks provided with dummy bridges is constructed such that the vertical pitch of bridges is changed toward the periphery of the shadow mask from the center thereof for the purpose of ensuring visibility (for example, Japanese Patent Application Laid Open No. 2001-84918, paragraphs 0039-0043).

As another countermeasure against the deterioration of visibility resulting from the provision of the real and dummy bridges, another example of the shadow masks includes the real and dummy bridges different in size (for example, Japanese Patent Application Laid-Open No. 2001-43808, paragraph 0019 and FIG. 4).

Still another example of the shadow masks is constructed such that the vertical length of a region containing only dummy bridges is 0.1 to 50 percent of the vertical length of the shadow mask (for example, Japanese Patent Application Laid-Open No. 2001-312976, paragraph 0018).

A further example of the shadow masks is constructed such that the number of real bridges are decreased gradually from the center of the mask toward the periphery thereof (for example, Japanese Patent Application Laid-Open No. 2002-42670, paragraph 0020 and FIG. 6).

The above-mentioned shadow masks present a problem in that a change in the density of the provided real bridges within a screen causes the density of irradiated electron beams to be accordingly distributed, thereby impairing good visibility of the screen such as impairing brightness uniformity.

Further, each of the above-mentioned shadow masks includes a smaller number of real bridges. Since the real bridges mechanically couple adjacent strips together, the shadow mask has a flat structure. If subjected to vibration from the outside of the color cathode ray tube, the shadow mask having the flat structure is prone to produce vibration (surface vibration), to provide a disadvantageous screen vibration characteristic of the color cathode ray tube.

For instance, the shadow mask disclosed in Japanese Patent Application Laid-Open No. 2001-312976 wherein the vertical length of the region containing only the dummy bridges is not greater than 50 percent of the vertical length of the shadow mask shows that not less than half of the screen has the flat structure, to make the problem of the screen vibration characteristic due to vibration more pronounced.

Additionally, the increase in the number of real bridges in the center of the mask as in Japanese Patent Application Laid-Open No. 2002-42670 causes adjacent strips to be more closely tied to each other in the center of the mask and to be more prone to vibrate, resulting in conspicuous vibration of the screen of the color cathode ray tube.

### SUMMARY OF THE INVENTION

It is an object of the present invention to provide a shadow mask for a color cathode ray tube capable of ensuring good screen visibility and improving a screen vibration characteristic, and to provide the color cathode ray tube.

According to a first aspect of the present invention, a shadow mask for a color cathode ray tube includes a plurality of strips, real bridges and dummy bridges. The real bridges connect the strips adjacent to each other. The dummy bridges are formed in cantilevered fashion on a side part of the strips. A region in which only the dummy bridges are present among the dummy bridges and the real bridges is defined as a first region, and a mixed region having the dummy bridges and the real bridges is defined as a second region. The size of the dummy bridges in the first region is greater than the size of the dummy bridges in the second region.

The shadow mask can maintain a balance in the amount of passage of electron beams between the first region and the second region to ensure good screen visibility.

According to a second aspect of the present invention, a shadow mask for a color cathode ray tube includes a plurality of strips, and real bridges. The real bridges connect the strips adjacent to each other. A striped mask region devoid of the real bridges is defined as a first region, and a region having the real bridges is defined as a second region. A slit opening width in the first region is less than a slit opening width in the second region.

The shadow mask can maintain a balance in the amount of passage of electron beams between the first region and the second region to ensure good screen visibility.

According to a third aspect of the present invention, a color cathode ray tube includes a glass tube body and a shadow mask. The glass tube body has a faceplate panel. The shadow mask is provided inside the faceplate panel. The shadow mask includes a plurality of strips, real bridges and dummy bridges. The real bridges connect the strips adjacent to each other. The dummy bridges are formed in cantilevered fashion on a side part of the strips. A region in which only the dummy bridges are present among the dummy bridges and the real bridges is defined as a first region, and a mixed region having the dummy bridges and the real bridges is defined as a second region. The size of the dummy bridges in the first region is greater than the size of the dummy bridges in the second region.

The color cathode ray tube can ensure good screen visibility and improve a screen vibration characteristic.

According to a fourth aspect of the present invention, a color cathode ray tube includes a glass tube body and a shadow mask. The glass tube body has a faceplate panel. The shadow mask is provided inside the faceplate panel. The shadow mask includes a plurality of strips, and real bridges. The real bridges connect the strips adjacent to each other. A striped mask region devoid of the real bridges is defined as a first region, and a region having the real bridges is defined as a second region. A slit opening width in the first region is less than a slit opening width in the second region.

The color cathode ray tube can ensure good screen visibility and improve a screen vibration characteristic.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic sectional view showing the construction of a color cathode ray tube including a shadow mask according to a first preferred embodiment of the present invention;

FIG. 2 is a schematic perspective view showing the construction of the shadow mask;

FIG. 3 is a general plan view of the shadow mask;

FIG. 4 is a plan view on an enlarged scale showing a part of the shadow mask;

FIG. 5 is a plan view on an enlarged scale showing a part of FIG. 4;

FIG. 6 is a plan view on an enlarged scale showing a part of another example of the shadow mask;

FIG. 7 is a plan view on an enlarged scale showing a part of a shadow mask of a color cathode ray tube according to a second preferred embodiment of the present invention;

FIG. 8 is a plan view on an enlarged scale showing a part of another example of the shadow mask; and

FIG. 9 is a plan view on an enlarged scale showing a part of still another example of the shadow mask.

### DESCRIPTION OF THE PREFERRED EMBODIMENTS

The present invention will now be described with reference to the drawings showing preferred embodiments.

<First Preferred Embodiment>

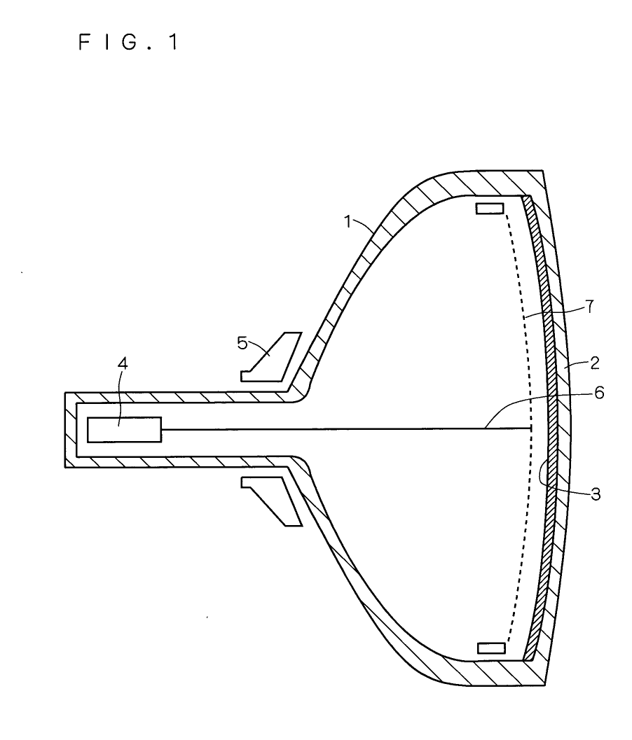

FIG. 1 is a schematic sectional view of a color cathode ray tube including a shadow mask according to a first preferred embodiment of the present invention.

In the color cathode ray tube shown in FIG. 1, a phosphor screen 3 is provided on the inner surface of a faceplate panel 2 in a glass tube body 1, and a shadow mask 7 for screening electron beams 6 emitted from electron guns 4 and scanned by an electromagnetic deflection element 5 to irradiate the phosphor screen 3 with only effective components is provided inside the faceplate panel 2.

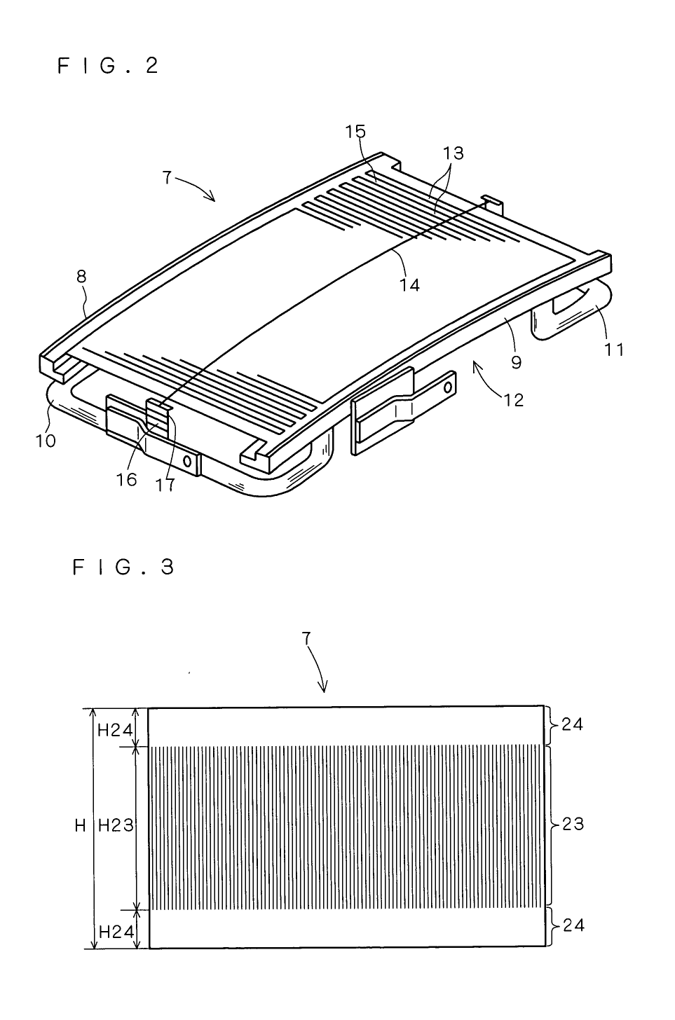

The shadow mask 7 shown in FIG. 2 is known as an aperture grille constructed by laying a multiplicity of strips 13 in a tensioned condition in a rectangular metal frame 12 formed by coupling opposite ends of a pair of upper and lower horizontal support members 8 and 9 to a pair of left-hand and right-hand elastic members 10 and 11 of inclined U shape. A damper wire 14 for vibration isolation is laid in a tensioned condition on the surface of the shadow mask 7. The strips 13 are elongated and narrow pieces, and are arranged horizontally in the tensioned condition between the upper and lower support members 8 and 9 of the above-mentioned metal frame 12 whereby a slit 15 serving as a beam passage opening is formed between adjacent strips 13. The damper wire 14 for vibration isolation is provided to suppress the deterioration of image quality due to flickering of picture resulting from the resonance of the shadow mask 7 by external vibration. The damper wire 14 is a fine wire made of, for example, tungsten, and the opposite ends thereof are seam-welded to respective damper springs 16 through metal ribbons 17.

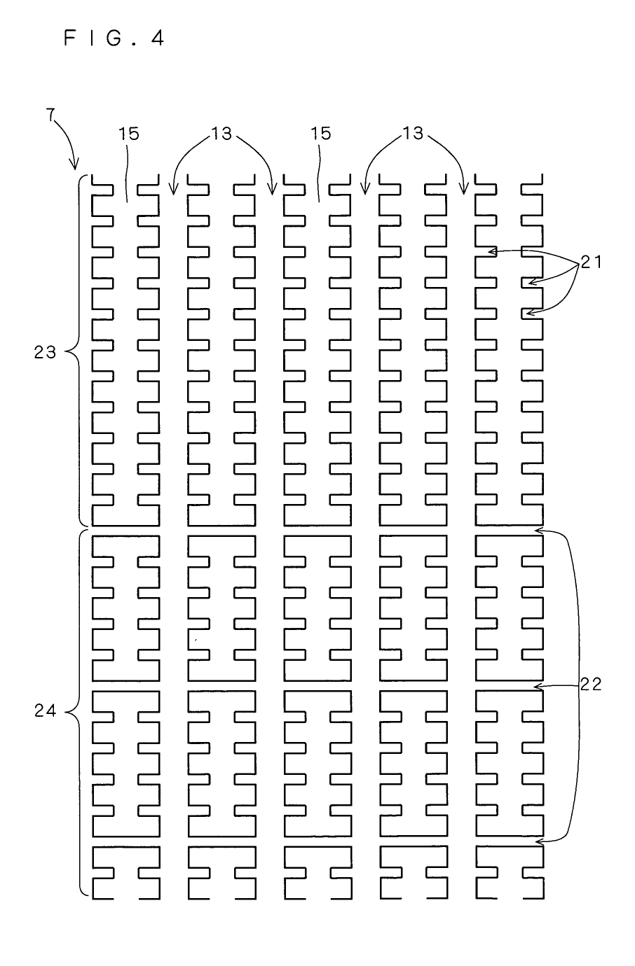

The entire surface of the above-mentioned shadow mask 7 has a region 23 in which the above-mentioned strips 13 have only dummy bridges 21 (FIG. 4), and a mixed region 24 in which the strips 13 have both the dummy bridges 21 and real bridges 22 (FIG. 4), as schematically illustrated in the plan view of FIG. 3.

FIG. 4 is a view on an enlarged scale showing a part of the surface of the above-mentioned shadow mask 7. As shown in FIG. 4, the dummy bridges 21 are cantilevered pieces extending horizontally from opposite sides of the strips 13. In this example, the dummy bridges 21 extend on opposite sides in the same longitudinal position of the strips 13. The real bridges 22 are elongated pieces extending horizontally from a side of the strips 13 and coupled to adjacent strips 13.

In the mixed region 24 having the dummy bridges 21 and the real bridges 22, the size of the dummy bridges 21 is specified from the viewpoint of screen visibility.

If the size of the dummy bridges 21 is too small, the amount of passage of the electron beams through the slits 15 increases in a portion where the dummy bridges 21 are provided. Thus, the screen becomes brighter, and the relative darkness of a portion of the screen where the real bridges 22 are provided is conspicuous. If the size of the dummy bridges 21 is too large, on the other hand, the brightness of the portion where the real bridges 22 are provided is conspicuous. In either case, there is a problem from the viewpoint of visibility.

For these reasons, the size of the dummy bridges 21 in the mixed region 24 is optimized in association with the size of the real bridges 22.

For the mixed region 24 having the dummy bridges 21 and the real bridges 22 the size of which is determined after the above-mentioned consideration, if the size of the dummy bridges 21 in the region 23 having only the dummy bridges 21 is made equal to, for example, the size of the dummy bridges 21 in the mixed region 24, the amount of passage of the electron beams per unit area is greater in the region 23 having only the dummy bridges 21 by the amount the real bridges 22 are not provided. As a result, there arises a difference in brightness between the regions 23 and 24 (the region 23 having only the dummy bridge 21 is brighter).

In the first preferred embodiment, the size of the dummy bridges 21 in the region 23 having only the dummy bridges 21 is made greater than the size of the dummy bridges 21 in the mixed region 24 having both the dummy bridges 21 and the real bridges 22, whereby the occurrence of the brightness difference between the regions 23 and 24 is avoided.

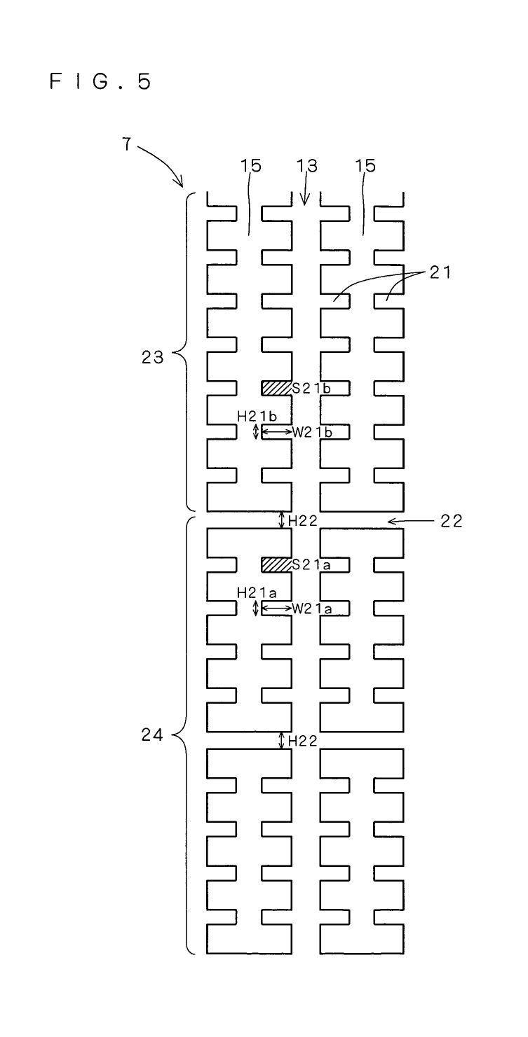

A specific example is shown in FIG. 5 which is a view on an enlarged scale showing a part of FIG. 4. Referring to FIG. 5, the optimum values of the sizes H21a, H22, W21 a, S21 a of the bridges in the mixed region 24 having the dummy and real bridges 21 and 22 are determined as above described from the relationship therebetween. In FIG. 5, H21a, W21a, S21a are the vertical size, the horizontal size and the area of the dummy bridge 21 in the mixed region 24a, H22 is the vertical size of the real bridge 22, and H21b, W21b, S21b are the vertical size, the horizontal size and the area of the dummy bridge 21 in the region 23 having only the dummy bridges 21.

If H21b=H21a, consideration is given to the visibility of the boundary between the regions 23 and 24, and W21b>W21a. That is, the horizontal size of the dummy bridge 21 in the region 23 is made greater than the horizontal size of the dummy bridge 21 in the mixed region 24. This maintains a balance in the amount of passage of the electron beams between the region 23 having only the dummy bridges 21 and the mixed region 24, to provide the color cathode ray tube screen with good visibility. Preferably, W21b ranges from 1.03×W21a to 1.55×W21a, thereby providing the screen with better visibility.

If W21b=W21a, then H21b>H21a. That is, the vertical size of the dummy bridge 21 in the region 23 is made greater than the vertical size of the dummy bridge 21 in the mixed region 24. This also maintains the balance in the amount of passage of the electron beams between the region 23 having only the dummy bridges 21 and the mixed region 24, to provide the color cathode ray tube screen with good visibility. Preferably, H21b ranges from 1.02×H21a to 1.52×H21a, thereby providing the screen with better visibility.

The above examples are those in which the dummy bridges 21 in the regions 23 and 24 are equal in vertical size and in which they are equal in horizontal size. However, the vertical size and the horizontal size may be different from each other. In this case, the area S21b of the dummy bridge 21 in the region 23 is made greater than the area S21a of the dummy bridge 21 in the mixed region.

The dummy bridges 21 according to the first preferred embodiment are substantially rectangular in shape for purposes of convenience. However, if the dummy bridges 21 are substantially elliptical, substantially trapezoidal or substantially triangular in shape depending on various manufacturing conditions of the shadow mask 7, the size of the dummy bridges 21 may be similarly set, whereby the color cathode ray tube screen has good visibility.

Referring to FIG. 3 which shows the entire surface of the shadow mask 7, the vertical size H23 of the region 23 having only the dummy bridges 21 is made greater than 50 percent of the vertical size of the shadow mask 7, i.e., the sum H of the vertical sizes H23 and H24 of the regions 23 and 24 according to the first preferred embodiment.

As with vibrations, it is necessary to consider surface vibration resulting from the presence of the real bridges 22 and chord vibration resulting from the absence of the real bridge 22 (that is, the strips 13 are in the form of stripes). Stretching the strips 13 damps the chord vibration but does not successfully damp the surface vibration. The background art shadow mask in Japanese Patent Application Laid-Open No. 2001-312976 shows that the vertical size H23 is made not greater than 50 percent of the vertical size H. However, the shadow mask in this case is strongly affected by the surface vibration to present a practical problem in terms of visibility. Making the vertical size H23 greater than 50 percent of the vertical size H as in the first preferred embodiment suppresses the surface vibration to improve the screen vibration damping effect for both of the chord vibration and the surface vibration. This has been verified by a visibility experiment under predetermined vibration conditions.

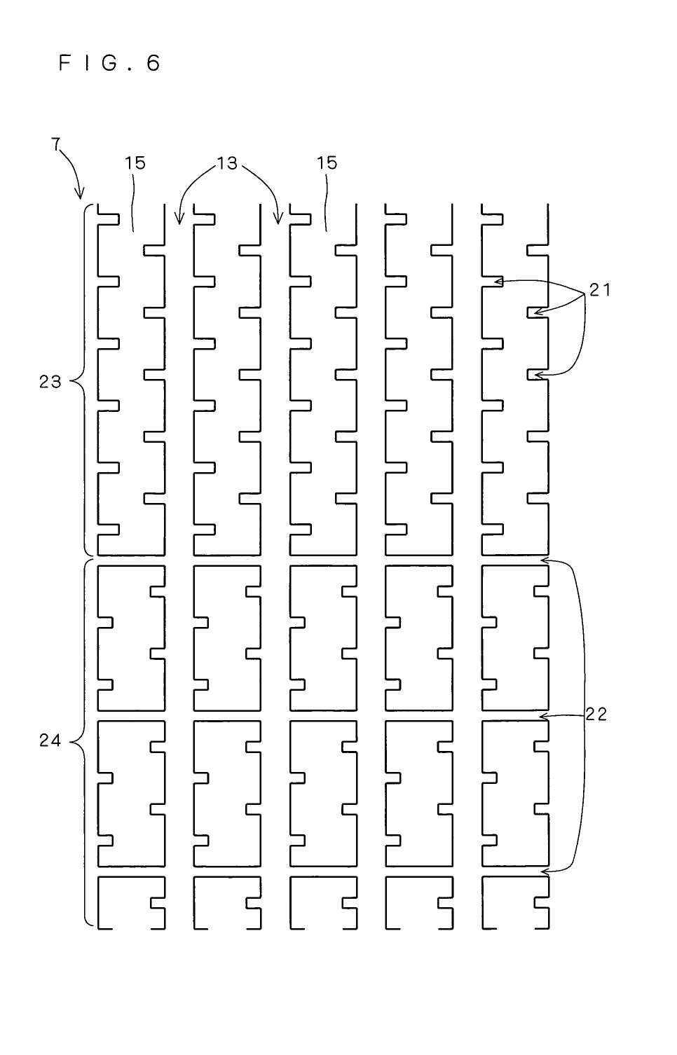

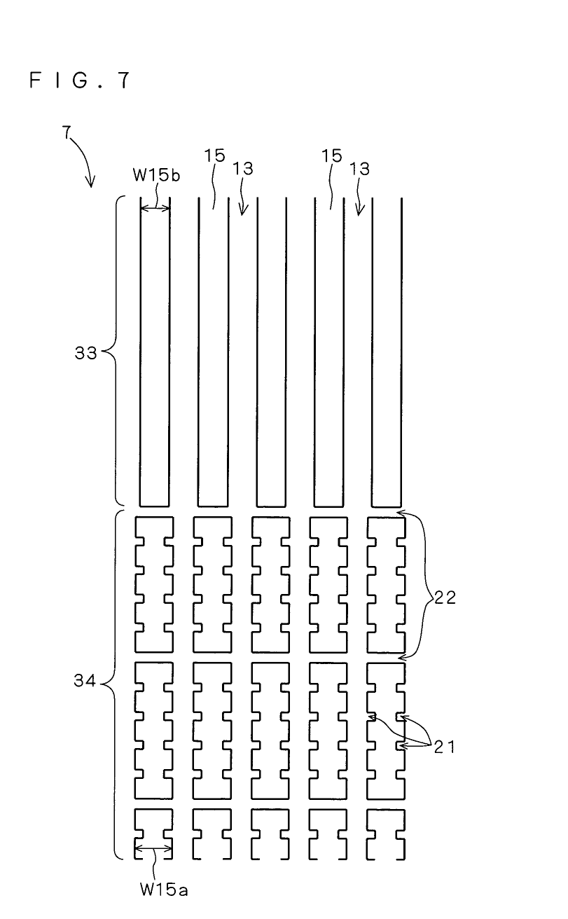

FIG. 6 is a partial plan view on an enlarged scale showing another example of the shadow mask 7 according to the first preferred embodiment. This shadow mask 7 shows an example in which the dummy bridges 21 extending horizontally from the right-hand side of the strips 13 and the dummy bridges 21 extending horizontally from the left-hand side of the strips 13 are provided in different longitudinal positions of the strips 13.

The relationship between the size of the dummy bridge 21 in the region 23 having only the dummy bridges 21 and the size of the dummy bridge 21 in the mixed region 24 and other structures are identical with those of the aforementioned example, and will not be described.

In the case of the shadow mask 7 in which the left-hand and right-hand dummy bridges 21 are in different longitudinal positions of the strips, the color cathode ray tube screen with similarly good visibility is provided.

<Second Preferred Embodiment>

FIG. 7 is a plan view on an enlarged scale showing a part of the shadow mask for the color cathode ray tube according to a second preferred embodiment of the present invention. The shadow mask 7 has a striped mask region 33 in which the strips 13 have no dummy bridges 21 on opposite sides thereof, and a mixed region 34 in which the strips 13 have both the dummy bridges 21 and real bridges 22 on opposite sides thereof. The left-hand and right-hand dummy bridges 21 extend horizontally in the same longitudinal position of the strips 13.

In the shadow mask 7, if the opening width W15b of the slit 15 in the striped mask region 33 is equal to the opening width W15a of the slit 15 in the mixed region 34, the amount of passage of the electron beams per unit area is smaller in the mixed region 34 than in the striped mask region 33 by the amount of the presence of the dummy bridges 21 and the real bridges 22. As a result, there arises a problem in that a portion of the mixed region 34 is accordingly darker on the screen.

To avoid the above-mentioned problem, the relationship between the slit opening widths in the regions 33 and 34 is W15b<W15a in the second preferred embodiment. That is, the slit opening width W15a in the mixed region 34 is made greater than the slit opening width W15b in the striped mask region 33.

This maintains a balance in the amount of passage of the electron beams between the striped mask region 33 and the mixed region 34 having the dummy bridges 21 and the real bridges 22, to ensure good screen visibility.

The vertical size of the striped mask region 33 is made greater than 50 percent of the vertical size of the entire shadow mask according to the second preferred embodiment.

Thus, the second preferred embodiment improves the screen vibration damping effect for both of the chord vibration and the surface vibration, as in the first preferred embodiment. This has been verified by a visibility experiment under predetermined vibration conditions.

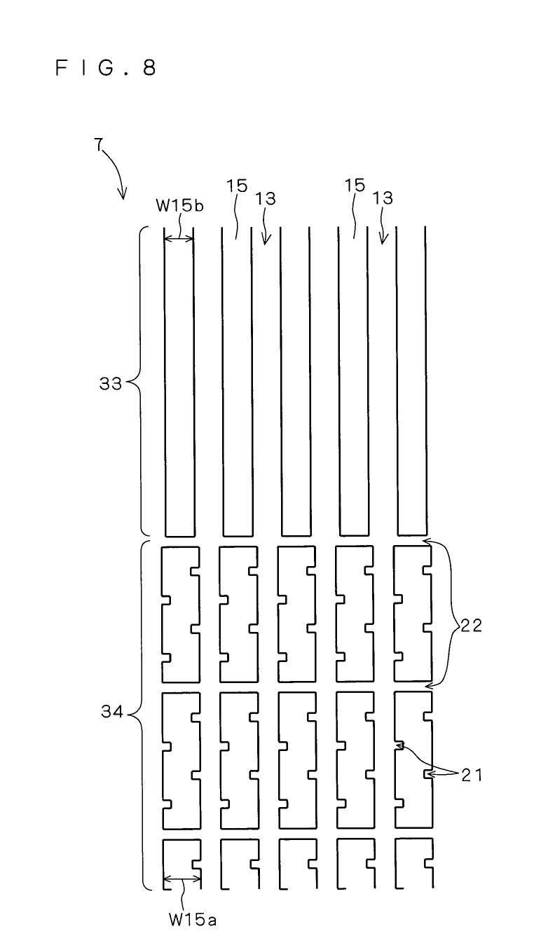

FIG. 8 is a partial plan view on an enlarged scale showing another example of the shadow mask 7 according to the second preferred embodiment. This shadow mask 7 shows an example in which the dummy bridges 21 extending horizontally from the right-hand side of the strips 13 and the dummy bridges 21 extending horizontally from the left-hand side of the strips 13 are provided in different longitudinal positions of the strips 13. The relationship between the slit opening width W15b in the striped mask region 33 and the slit opening width W15a in the mixed region 34 and other structures are identical with those of the aforementioned example, and will not be described.

In the case of the shadow mask 7 in which the left-hand and right-hand dummy bridges 21 are in different longitudinal positions of the strips, the color cathode ray tube screen with similarly good visibility is provided.

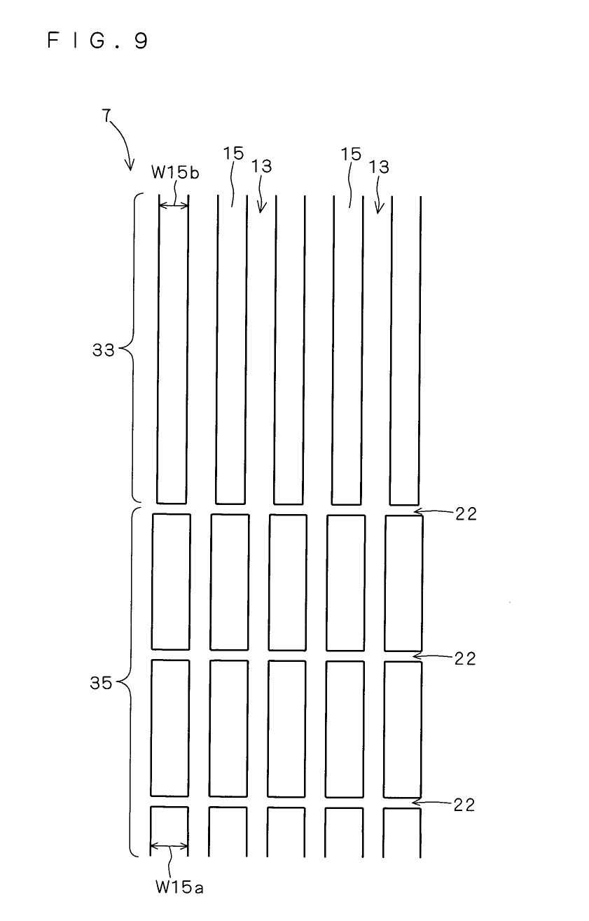

FIG. 9 is a partial plan view on an enlarged scale showing still another example of the shadow mask 7 according to the second preferred embodiment. This shadow mask 7 shows an example in which the dummy bridges 21 are dispensed with. Specifically, the shadow mask 7 includes the striped mask region 33 and a region 35 having only the real bridges 22. The relationship between the slit opening width W15b in the striped mask region 33 and the slit opening width W15a in the region 35 having only the real bridges 22 and other structures are identical with those of the aforementioned example, and will not be described.

Thus, in the case of the shadow mask 7 in which the left-hand and right-hand dummy bridges 21 are dispensed with, the color cathode ray tube screen with similarly good visibility is provided.

While the invention has been described in detail, the foregoing description is in all aspects illustrative and not restrictive. It is understood that numerous other modifications and variations can be devised without departing from the scope of the invention.

What is claimed is:

1. A shadow mask for a color cathode ray tube, comprising:
a plurality of strips;
real bridges for connecting said strips adjacent to each other; and
dummy bridges formed in cantilevered fashion on a side part of said strips,
wherein a region in which only said dummy bridges are present among said dummy bridges and said real bridges is defined as a first region, and a mixed region having said dummy bridges and said real bridges is defined as a second region, and
wherein the size of said dummy bridges in said first region is greater than the size of said dummy bridges in said second region.

2. The shadow mask according to claim 1, wherein
the vertical dimension of said first region is greater than 50 percent of the vertical dimension of said shadow mask.

3. A shadow mask for a color cathode ray tube, comprising
a plurality of strips; and
real bridges for connecting said strips adjacent to each other,
wherein a striped mask region devoid of said real bridges is defined as a first region, and a region having said real bridges is defined as a second region, and
wherein a slit opening width in said first region is less than a slit opening width in said second region.

4. The shadow mask according to claim 3, wherein
the vertical dimension of said first region is greater than 50 percent of the vertical dimension of said shadow mask.

5. A color cathode ray tube comprising:
a glass tube body having a faceplate panel; and
a shadow mask provided inside said faceplate panel,
said shadow mask including
a plurality of strips,
real bridges for connecting said strips adjacent to each other, and
dummy bridges formed in cantilevered fashion on a side part of said strips,
wherein a region in which only said dummy bridges are present among said dummy bridges and said real bridges is defined as a first region, and a mixed region having said dummy bridges and said real bridges is defined as a second region, and
wherein the size of said dummy bridges in said first region is greater than the size of said dummy bridges in said second region.

6. A color cathode ray tube comprising:
a glass tube body having a faceplate panel; and
a shadow mask provided inside said faceplate panel,
said shadow mask including
a plurality of strips, and
real bridges for connecting said strips adjacent to each other,
wherein a striped mask region devoid of said real bridges is defined as a first region, and a region having said real bridges is defined as a second region, and
wherein a slit opening width in said first region is less than a slit opening width in said second region.
